(19) United States
(12) Patent Application Publication
(10) Pub. No.: US 2026/0312836 A1
(43) Pub. Date: Oct. 8, 2026

(54) CHUNK BASED MODULAR VIDEO PROCESSING

(71) Applicant: Clari Inc., Sunnyvale, CA (US)

(72) Inventors: Shlok WALIA, Delhi (IN); Srinjoy CHOUDHURY, Kolkata (IN); Kalpit MANGLUNIYA, Jaipur (IN)

(21) Appl. No.: 19/171,794

(22) Filed: Apr. 7, 2025

(51) Int. Cl. H04L 12/18; H04N 19/436

(52) U.S. Cl. CPC H04L 12/1831; H04N 19/436

(57) ABSTRACT

A data processing system is configured to receive, by a recording service, a stream of images from a video streaming source. The recording service encodes the stream of images, resulting in encoded images with corresponding metadata. The recording service generates a plurality of chunks, each one of the plurality of chunks includes a group of the encoded images and the metadata corresponding to the encoded images. The recording service stores the plurality of chunks to data storage, and transmits a plurality of messages to a message server. Each one of the plurality of messages corresponds to one of the plurality of chunks. The data processing system generates an encoded video, including encoding the plurality of chunks in parallel, based on the plurality of messages, and combining the encoded chunks.

### TECHNICAL FIELD

Embodiments of the present disclosure relate generally to a data processing system and more particularly, embodiments of the disclosure relate to a chunk based image-processing pipeline for video.

### BACKGROUND

Data processing systems may include computer readable memory that stores machine executable instructions that can be performed by a processor. The instructions may be grouped together in terms of functionality to what is referred to as an application. Applications may be stored and performed locally at a user's machine, or they may be performed by remotely by a data processing system over a computer network, in what may be referred to as a cloud-based application.

Data processing systems on computer networks (e.g., the internet) provide a variety of services to users. Data processing systems that interface with and provide services to other devices over a computer network may be referred to as servers. Servers may encode and transmit captured video data. Encoding of video data is computationally heavy, requiring processing bandwidth, memory, and time. It is desirable for a data processing system to implement an efficient and low latency technologies to process video data.

### BRIEF DESCRIPTION OF THE DRAWINGS

Embodiments of the disclosure are illustrated by way of example and not limited to the figures of the accompanying drawings in which like references indicate similar elements.

FIG. 1 shows an example data processing system for encoding a video, in accordance with an embodiment.

FIG. 2 shows an example data processing system for encoding a video using a plurality of encoding services, in accordance with an embodiment.

FIG. 3 illustrates an example method for processing and encoding a video stream, in accordance with an embodiment.

FIG. 4 shows an example of a data processing system for parallel video processing, in accordance with an embodiment.

FIG. 5 shows an example embodiment of a distributed data processing system for processing a video, in accordance with an embodiment.

FIG. 6 is a block diagram illustrating an example of a data processing system, in accordance with an embodiment.

### DETAILED DESCRIPTION

Computing devices may be accessible over a computer network to provide one or more services. This may be referred to as cloud computing, in which these computing devices provide on-demand access to computing resources over the internet. Such service includes servers, data storage, applications, networking, email, etc. Cloud computing may be available to the public (e.g., public cloud), on a private network (e.g., private cloud), or a hybrid thereof.

Cloud computing may include networked servers that store and/or process data. Such networked servers may provide coordinated functionality in what may be referred to as a data platform. For example, a data platform may support video capture such as, for example, meetings, videoconferences, virtual video conferences, etc. The data platform may comprise application programming interface (API) for other network nodes to connect with the data platform and download video in a select format. In such a case, it may be advantageous to encode an entire video capture in the select format, with reduced latency and in a robust manner that is resistant to network interruptions.

An API or API endpoint may be understood as a computer call from one computer application to another computer application using a pre-defined format (e.g., an API call). Each transmission or receiving of data between computer applications and/or computer devices in the present disclosure may be made through an API call through a computer network protocol (e.g., TCP/IP, etc.).

Video processing systems may face a host of challenges related to processing captured video. These video processing systems may receive a stream of video frames, and be tasked to complete processing this entire capture within a threshold amount of time after the stream ends. It is desirable for these processing system to be resilient and fault-tolerant. Some solutions may process the stream of video frames at the source of capture or in real-time, while others may process the entire video after the stream is complete (e.g., the video capture has ended). The video processing system may serve clients with an encoded version of the video capture. Significant drawbacks of existing video processing systems include expensive recording hardware and a lack of fault tolerance in case of network disconnection at the source. Further, industry standards include processing the video after the live stream ends, but systems face the challenge of processing each video capture within a definitive amount of time. Instead, solutions may vary in processing time based on the duration of the video capture. For example, the processing time of existing systems may be a function of Y * video duration, where Y is a factor that varies depending upon the processing system's hardware and encoding standards used. Some real-time video encoding solutions are also available but are challenging to implement and maintain on a large scale. These real-time systems require direct network connections to the live-streaming source, and if the connection disconnects or delays, the entire video must be processed again. Therefore, there is a need for a robust, fault-resistant video processing system that processes a video capture after the video capture is complete, within a predictable time period that varies less based on the video duration and other factors.

Aspects of the present disclosure relate to a data processing system that utilizes parallel and distributed processing to encode video systems with reduced latency, reduced variance in processing time, and improved resistance to network disruptions. A data processing system may have dedicated services working independently, in a coordinated manner, to encode a video within a predetermined time period, regardless of the duration of the video. In such a manner, shortly after a video capture is done (e.g., a video capture of a video conference), the encoded video may be ready for download.

In an aspect, a data processing system is configured to perform operations comprising receiving, by a recording service, a stream of images from a video streaming source, encoding, by the recording service, the stream of images, resulting in encoded images with corresponding metadata, generating, by the recording service, a plurality of chunks, each one of the plurality of chunks comprising a group of the encoded images and the metadata corresponding to the encoded images, storing, by the recording service, the plurality of chunks to data storage, and transmitting, by the recording service, a plurality of messages to a message server, wherein each one of the plurality of messages corresponds to one of the plurality of chunks. The data processing system may generate an encoded video by encoding the plurality of chunks in parallel, based on the plurality of messages.

In an embodiment, a plurality of encoding services are subscribed to the messaging server and receive a message as soon as the message server has a message to be consumed. The encoding services will each consume a respective message (e.g., corresponding to a single chunk), and download and encode that chunk. In an embodiment, generating the encoded video comprises: receiving, by a first encoding service, a first message of the plurality of messages from the message server, based on receiving a notification from the message server that one of the plurality of messages is received by the message server, downloading, by the first encoding service, a first chunk of the plurality of chunks from the data storage, based on the first message, encoding, by the first encoding service, the first chunk with a codec to generate a first encoded chunk, and storing, by the first encoding service, the first encoded chunk to the data storage, receiving, by a second encoding service, a second message of the plurality of messages from the message server, based on receiving a second notification from the message server that one of the plurality of messages is received by the message server, downloading, by the second encoding service, a second chunk of the plurality of chunks from the data storage, based on the second message, encoding, by the second encoding service, the second chunk with the codec to generate a second encoded chunk, and storing, by the second encoding service, the second encoded chunk to the data storage.

In an embodiment, encoding the first chunk by the first encoding service and the encoding the second chunk by the second encoding service is performed in parallel. Each of the encoding services may work independently and asynchronously, so that the final encoded video may be ready in a time that is decoupled from the duration of the original image stream.

In an embodiment, generating the encoded video comprises determining, by the second encoding service, based on the metadata corresponding to the second chunk, that the second chunk is a last chunk of the plurality of chunks. In response to determining that the second chunk is the last chunk, the second encoding service transmits a message to a combiner service indicating that the last chunk is processed.

In an embodiment, generating the encoded video comprises: receiving, by the combiner service, the message indicating that the last chunk of the plurality of chunks is processed, in response to receiving the message, downloading, by the combiner service, the first encoded chunk and the second encoded chunk from the data storage; and concatenating a plurality of encoded chunks including the first encoded chunk and the second encoded chunk, to generate the encoded video.

In an embodiment, concatenating the plurality of encoded chunks comprises determining a sequential order of the plurality of encoded chunks based on the metadata, and concatenating the plurality of encoded chunks in the sequential order.

In an embodiment, the data processing system is further configured to transmit the encoded video to a user device. For example, the data processing system may comprise an application programming interface (API) or user interface (UI) that receives user input requesting to download an encoded video. Using the operations described, the data processing system may make this encoded video available within a short or predetermined duration of time after the video capture ends, and this duration may be independent of video duration. The data processing system may transmit the encoded video to the user over a computer network, understanding that a raw video would be orders of magnitude larger and result in an unacceptable download time and/or burden on the network.

In an embodiment, the data processing system may include encoding services that are grouped to, in parallel, to generate different versions (e.g., different encoding) of the same video capture. For example, generating the encoded video may comprise combining a first plurality of encoded chunks to generate a first encoded video, and combining a second plurality of encoded chunks to generate a second encoded video. In an embodiment, the first plurality of encoded chunks are generated by a plurality of first encoding services using a first codec, and the second plurality of encoded chunks are generated by a second plurality of encoding services using a second codec. In another embodiment, the each of the plurality of encoding services may be configured to apply multiple codecs (or the same codec but with different parameters) to each single chunk, to ultimately generate multiple versions of the same video.

In an embodiment, the metadata comprises a timestamp or a sequence associated with the group of encoded images relative to the stream of images. In an embodiment, the recording service may store the associated metadata in each chunk (e.g., as a file). The respective encoding service that pulls that chunk may read and store the metadata to a database. The combiner service may access the database to read this metadata.

In an embodiment, generating, by the first service, the plurality of chunks, is performed while the capture of the stream of images is still ongoing. For example, during a video conference, the first service may be receiving the images as they are being captured, image by image and frame by frame. While this image stream is being received, the first service may encode and chunk the images, store the chunks to data storage, and send the corresponding messages to the messaging service for processing. Meanwhile, the each of the encoding services are receiving notifications that these chunks are available for processing and actively obtaining and processing these chunks, while the video capture is still ongoing. By the time the video capture is complete, a substantial amount of the chunks are already encoded and stored. Once the last chunk is processed, the combiner service will access the encoded chunks from data storage and stitch them together, which is a relatively short operation, relative to encoding the entire image stream.

In such a manner, the data processing system may process video and provide a final video output with reduced latency. Rather than processing live streams in sequence or in large segments, which may cause delays, particularly for lengthy videos, embodiments of the data processing system may process chunks independently parallel and/or asynchronous processing. The system further makes the final stitched video available within a definitive timeframe after the live stream ends, regardless of the entire video duration.

Further, aspects described are fault Tolerant. Existing solutions may sequentially process video frames, which can be vulnerable to cascading failures-a fault in processing of one segment of the video that may require restarting the entire video processing for that video capture. Instead, under embodiments of the described data processing system, a processing fault in one segment of the video does not impact processing of other segments of the video. The data processing system can reprocess those faulty segments without starting over, which improves robustness and minimizes downtime caused by potential processing errors.

Further, aspects described may process video with a consistent delivery time with reduced variation in processing time of videos. Existing solutions may process video with less consistent delivery time, due to this processing being more depending on video duration or size. Embodiments of the data processing system may timely deliver completely processed video capture, by using independent chunk processing (e.g., during a live stream or after) and stitching logic, which may be performed independent of the video duration.

Conventional industry solutions are video stream dependent, they are very tightly coupled with the source video stream and its data sequence. Existing solutions may be vulnerable to video live stream interruptions (e.g., due to network issues). When trying to encode a raw video capture, network interruptions or slowdowns may disrupt sequential processing, often requiring reprocessing the entire video.

With the data processing system described in the present disclosure, the chunk-based approach is resilient to stream interruptions. If the stream is interrupted, only the incomplete chunk is affected and needs to be processed. The other chunks were processed and stored prior to interruption, along with the corresponding metadata. When the interruption ends and the video stream resumes, chunking and processing can continue seamlessly. Further, the described data system is modular to accommodate different operations in the video processing pipeline. This modular system (e.g., separate dedicated services) is suitable for cloud and distributed systems.

Other technical features may be readily apparent to one skilled in the art from the following figures, descriptions, and claims.

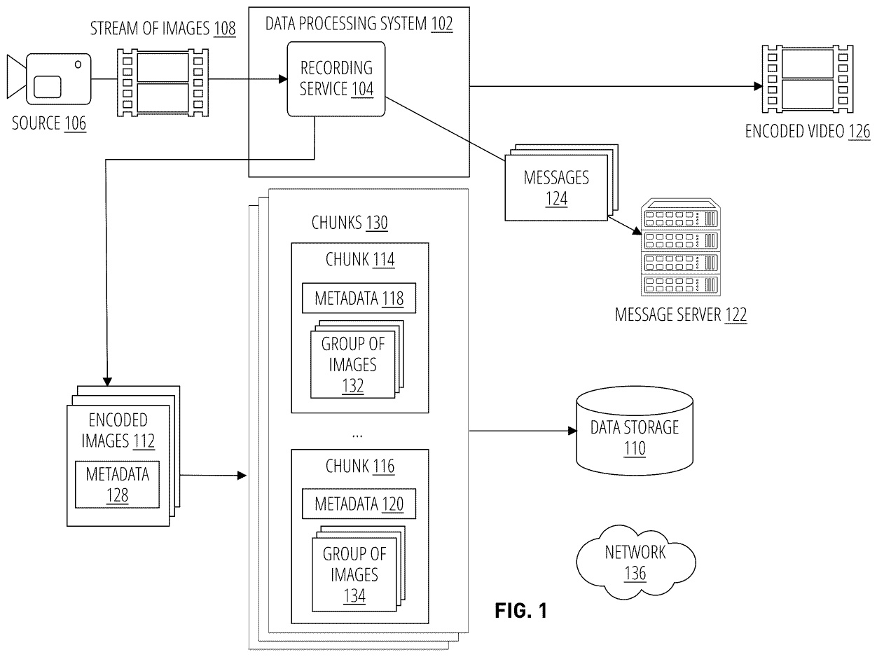

FIG. 1 shows an example data processing system for encoding a video, in accordance with an embodiment. A data processing system 102 may comprise processing logic which may include hardware (e.g., a processing device, computer-readable memory, transmitter, receiver, power supply, transmission lines, communication buses, etc.) and software (e.g., machine executable instructions stored on computer-readable memory) that is configured to perform the described functionality of a video processing engine (e.g., video processing engine 622). Aspects described with respect to FIG. 1 may apply to other sections and other figures, and vice versa.

The data processing system 102 may be communicatively coupled to other devices over a computer network 136. Data processing system 102 may represent a plurality of computers in wired or wireless communication with each other using one or more communication protocols (e.g., TCP/IP, Wi-fi, long-term evolution, new radio, etc.). Data processing system 102 may comprise a plurality of computing devices and/or services coupled to network 136, that may work together to perform related functionality (e.g., through a distributed computing architecture).

Data processing system may comprise a recording service 104. Recording service 104 may be a server connected to network 136. The recording service 104 may communicate over the computer network with other computing devices such as, for example, a video streaming source 106. The video streaming source 106 may be a computing device such as a camera, a mobile device, a computer, or a networked server.

The recording service 104 may receive a stream of images 108 from the video streaming source 106. In an embodiment, the video streaming source 106 may stream a video captured from a single camera. In another embodiment, video streaming source 106 may stream a composite stream of images formed from combining multiple streams of images together (e.g., camera streams from different participants of a video conference). The images may be captured from a traditional camera that generates images through sensed light, or a virtual camera (e.g., a stream of digitally generated images). In an embodiment, the stream of images 108 may be a stream of video frames where each frame has a fixed number of images over a fixed period of time. The video frames may be raw video frames. The video frames may have a conventionally known pixel format and frame dimensions over a network.

Recording service 104 may encode the stream of images, resulting in encoded images 112 with corresponding metadata 128. In an embodiment, each encoded image is encoded as a . jpg with a common predetermined resolution and/or dimensions. In an embodiment, recording service 104 uses a standard codec to encode the raw images to encoded images 112. In an embodiment, encoded images 112 are encoded as frames of jpeg images, each frame comprising a sequence of jpeg images over a period of time.

Recording service 104 generates a plurality of chunks 130, each one of the plurality of chunks comprising a group of the encoded images 112 and the metadata 128 corresponding to the encoded images. For example, a first chunk 114 may comprise a first group of images 132, and metadata 118. A second chunk 116 may comprise a second group of images 134 and corresponding metadata 120. The metadata may describe a timestamp and/or a sequence number of the respective images in that chunk. For example, metadata 118 may describe one or more timestamps of the group of images 132, or a sequence number of those group of images 132 indicating the order of those images relative to the other encoded images 112 (e.g., the first 200 frames, the second 200 frames, or more generally, the Nth order of M number of frames). Similarly, metadata 120 have the same relevant information for group of images 134. In an example, each chunk comprises M number of different non-overlapping frames of the encoded images 112. In an embodiment, the metadata in a chunk may be stored in a text-based file (e.g., a .txt, .log, or other text-based data file).

In an embodiment, the recording service 104 may generate each chunk using a lossless compression algorithm that combines multiple files into a single file. In an example, each chunk may be generated as a zip file containing the respective group of images and the metadata. The recording service 104 store the plurality of chunks 130 to data storage 110. Data storage 110 may comprise a cloud-based data storage that other services may access to obtain the chunks 130 for parallel processing, as described in other sections.

The recording service 104 transmits a plurality of messages 124 to a message server 122. Each one of the plurality of messages 124 corresponds to one of the plurality of chunks 130. The recording service 104 may process the stream of images 108 as they are received, for example, chunk by chunk. Each time a chunk is generated, the recording service 104 may store that chunk to the data storage 110 and send the corresponding message to the message server 122, before generating the next chunk. This way, a service may receive notification that a chunk is ready for encoding and encode it, as the recording service 104 continues to process the stream of images 108, thereby reducing overall processing time.

In an embodiment, the message server 122 is an event streaming system. In an embodiment, the message server 122 is a publish-subscribe messaging system (e.g., Apache Kafka™). When the recording service 104 stores the message to the message server, other processes that are subscribed to this message server 122 (e.g., a Kafka topic) may automatically receive a notification that a message is ready to be consumed. In an embodiment, a schema defines each message byte format. For example, a schema may define a structure of the byte array that defines the message, such as, for example, the order, size, number of, or type of fields in the message. The recording service 104 may generate and transmit each message in this serialized format to the message server 122. Similarly, each of the subscribers may use this schema to read the contents of each message.

The data processing system 102 may generate an encoded video 126 by encoding the plurality of chunks in parallel, based on the plurality of messages. For example, the data processing system 102 may have dedicated encoding services that consume each of the plurality of messages and, in response, perform the encoding of each chunk in parallel. Further, the data processing system 102 may comprise a dedicated combiner service to download and combine the encoded chunks, as discussed further in other sections. The data processing system 102 may concatenate encoded versions of the plurality of chunks 130 in sequential order to reconstruct the sequence of the stream of images 108, using the time stamp information and/or frame numbering of metadata in each chunk. The concatenation process may include unpacking all of the encoded versions of the chunks, ordering them according to the metadata, and forming a single digital file containing all of the encoded frames in the reconstructed ordering. The data processing system may store the encoded video 126 in data storage 110. A user may download this encoded video 126, or the data processing system may display and play back this encoded video 126 from the cloud, or both.

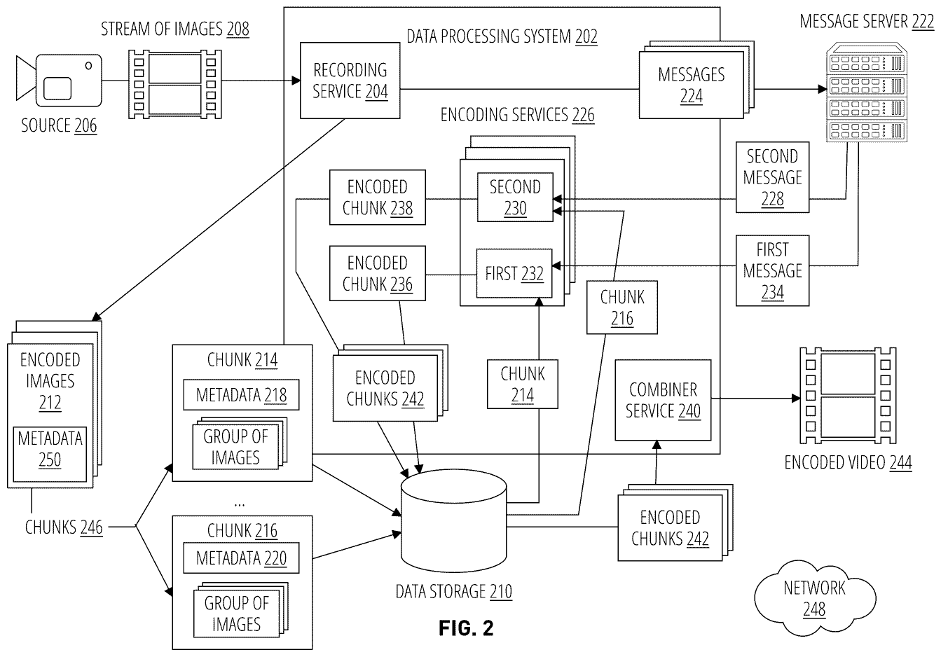

FIG. 2 shows an example data processing system for encoding a video using a plurality of encoding services, in accordance with an embodiment. A data processing system 202 may comprise processing logic which may include hardware (e.g., a processing device, computer-readable memory, transmitter, receiver, power supply, transmission lines, communication buses, etc.) and software (e.g., machine executable instructions stored on computer-readable memory) that is configured to perform the described functionality of a video processing engine (e.g., video processing engine 622). Aspects described with respect to FIG. 2 may correspond to aspects described in other sections or with respect to other figures.

The data processing system 202 may be communicatively coupled to other devices over a computer network 248. Data processing system 248 may represent a plurality of computers in wired or wireless communication with each other using one or more communication protocols. Data processing system 248 may comprise a plurality of computing devices and/or services coupled to network 248.

Data processing system may comprise a recording service 204. Recording service 204 may be a dedicated server connected to network 248, or a service running as part of a microservices application. The recording service 204 may communicate over network 248 with other computing devices such as, for example, a video streaming source 206, such as, for example, a mobile device, a server, a personal computer, a service, etc.) that has obtained or generated the stream of images 208.

The recording service may receive a stream of images 208 from the video streaming source 206. The stream of images 208 may comprise a stream of raw images that are not encoded, or in an undesirable format. The stream of images 208 may be received as a real-time video stream. In an embodiment, the stream of images is received as video frames (e.g., raw frames), having a conventionally known pixel format and frame dimensions.

The stream of images 208 may be an ongoing video capture, for example, the stream of images 208 may correspond to an ongoing event (e.g., a filming, a game play, a multi-player game play, a video conference, etc.) the stream of images 208 is still being captured by one or more cameras or virtual cameras.

The recording service 204 may apply an encoding algorithm to the stream of images 208, as they are received, resulting in encoded images 212 with corresponding metadata 250. The encoded images 212 may have a reduced memory footprint, or reduced resolution, relative to stream of images 208. In an embodiment, the encoded images 212 have a .jpg format. In an embodiment, the encoded images 212 are grouped by frames, e.g., N number of images in each frame. The metadata 250 may comprise timestamps of a given frame and/or each image. Additionally, or alternatively, the metadata 250 may include an indicator such as a sequence number indicating an order of the frame and/or image relative to the other frames and images in the stream of images 208.

The recording server 204 may generate a plurality of chunks 130, each one of the plurality of chunks comprising a group of the encoded images 112 and the metadata 128 corresponding to the encoded images. In an embodiment, each chunk may comprise a set number of frames. The chunk size (e.g., the number of frames in each chunk) can be constant, up until the last chunk, which may have the remaining frames.

The recording service 204 may store the plurality of chunks 246 to data storage 210. For each chunk, the recording service 204 transmits a corresponding message (e.g., messages 224) to a message server 222. The message server may comprise an event streaming platform, as described in other sections. A plurality of encoding services 226 may be subscribed to the message server 222, which configures the message server 222 to transmit a notification message to each of the encoding services 226 whenever it has received a message from the recording service 204. In an embodiment, once one of the encoding services 226 consumes a message from the message server 222 (e.g., through a request and response), the message server 222 may remove that message from consumption. The encoding services 226 will each consume a respective message (e.g., corresponding to a single chunk), and encode that chunk. This chunk encoding performed by the encoding services 226 may compress the images in each chunk to a desired resolution or identifies and removes redundant information between frames. Additionally, or alternatively, this encoding may size each of the images to a desired size (e.g., a desired length and width, aspect ratio, etc.).

For example, a first encoding service 232 consumes a first message 234 of the plurality of messages 224 from the message server 224, in response to receiving a notification from the message server 222 that one of the plurality of messages is received by the message server. The first encoding service 232 may read an identifier, an IP address, a name, a sequence number, and/or other metadata in this message indicating which chunk to download, and/or where to download the chunk from. The first encoding service 232 downloads a first chunk 214 of those chunks 246 previously uploaded by the recording service 204.

Once downloaded, the first encoding service 232 may unpack (e.g., unzip) the contents of the chunk, which includes the relevant group of encoded images 212 and relevant metadata 218, which may include timestamps and/or sequences of each image and/or frame in that chunk. First encoding service 232 may encode the first chunk 232 (e.g., with a codec) to generate a first encoded chunk 236. The first encoding service 232 stores the encoded chunk 236 to data storage 210.

A second encoding service 230 may consume a second message 228 of the plurality of messages 224 from the message server 222, in response to receiving a second notification from the message server that one of the plurality of messages 224 is available for consumption at the message server 222. The second encoding service 230 downloads a second chunk 216 of the plurality of chunks 246 from the data storage 210, based on the second message 228, for example, based on the chunk identifier, chunk address, chunk name, etc., that is in the second message 228. The second encoding service 230 encodes the second chunk 216 (e.g., with the same codec used by first encoding service 232) to generate a second encoded chunk 236. The second encoding service 230 may store the second encoded chunk 238 to the data storage 210.

In an embodiment, all of the plurality of encoded chunks generated by the encoding services 226 are stored in data storage 210, e.g., the same data storage. In an embodiment, all of the encoding services 226 may use the same codec or codecs to generate the plurality of encoded chunks 242. In an embodiment, the encoding services 226 may operate asynchronously and in parallel, for example, by consuming messages, downloading chunks, and encoding chunks in parallel, thereby reducing overall time to encode a video.

The number of encoding services 226 need not be the same as the number of chunks generated by the recording service 204. For example, a video capture may comprise 5000 chunks, but only 100 encoding services may be deployed to encode these chunks. In an embodiment, however, the recording service 204 may determine how many encoding services 226 are deployed, and generate the number of chunks based on the number of encoding services 226. For example, the number of chunks may be higher (less frames in each chunk) in response to an increase in the number of encoding services that are currently deployed, and the number of chunks may be lower (more frames in each chunk) in response to a decrease in the number of encoding services that are currently deployed. In an embodiment, the number of encoding services that are deployed may be dynamically adjusted based on user settings, or based on historical analysis. In an embodiment, the dynamic adjustment may be performed automatically, for example, during a first time period with historically peak hours of high video capture (e.g., working weekday hours), the system may increase a number of the plurality of encoding services. Similarly, during a second time window (e.g., in the late evening and/or weekends), the number of the plurality of encoding services may be decreased.

The data processing system 202 may generate an encoded video, based on the metadata 250 and based on combining the plurality of chunks (e.g., 214, 216, etc.). In an embodiment, a combiner service 240 may download the encoded chunks 242 from the data storage 210. The combiner service 240 may concatenate the plurality of encoded chunks 242 (which may include the first encoded chunk 236 and second encoded chunk 238), to generate the encoded video 244.

In an embodiment, one of the encoding services 226 may determine that the chunk that it is encoding is a last chunk, carrying a last image of the stream of images 208. This may be indicated by metadata that is stored in that chunk. That encoding service may send a message to combiner service 240, indicating that all chunks for a video capture are now in data storage 210 and ready to be combined. In response, the combiner service 240 may download all the chunks from the data storage 210, order them so that their respective frames and images match the frames and images of the original stream of images 208, and form the encoded video 244 with the frames arranged in that ordering. In an embodiment, the combiner service 240 may otherwise be asleep and not performing other duties, until it receives the signal from the encoding services 226 that the last chunk has been processed.

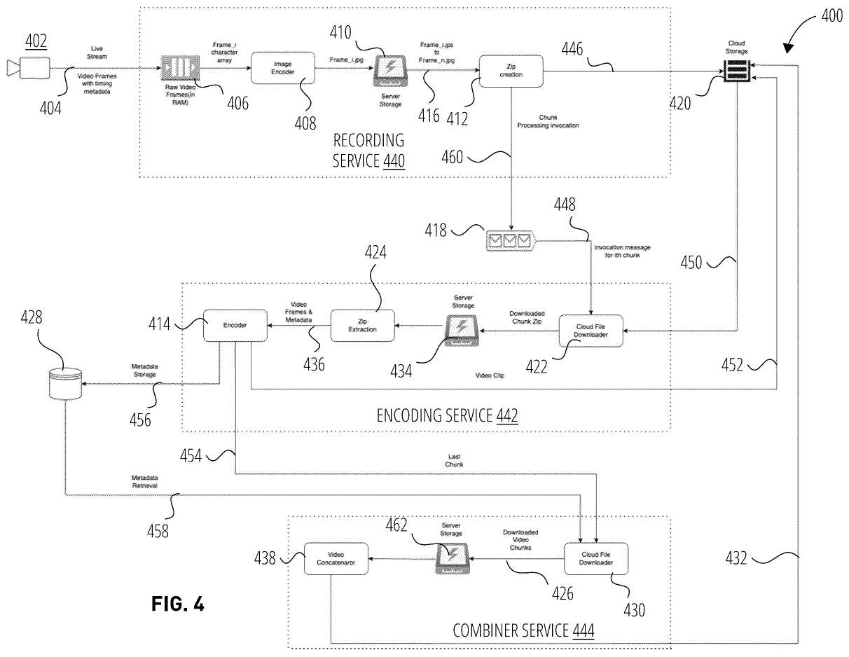

The combiner service 240 may use the metadata 250 to determine the proper order of the chunks. For example, metadata 218 may include timestamps and/or sequence numbers of the images or frames within chunk 214. Similarly, metadata 220 may include timestamps and/or sequence numbers of the images or frames in chunk 216. Each of the encoding services 228 may store this per-chunk metadata with each of the respective encoded chunks 242, or in a separate metadata database (e.g., as shown in FIG. 4).

Services such as combiner service 240, encoding services 226, and recording service 204 may be separate services, each with their own dedicated compute resources (e.g., processing bandwidth, memory, network bandwidth, etc.). In an embodiment, some or all of the services may be hosted on different physical servers over a computer network. In an embodiment, the services may be part of a microservices application, each communicating with each other through inter-service communication using a respective an application programming interface (API), over a dedicated communication backplane.

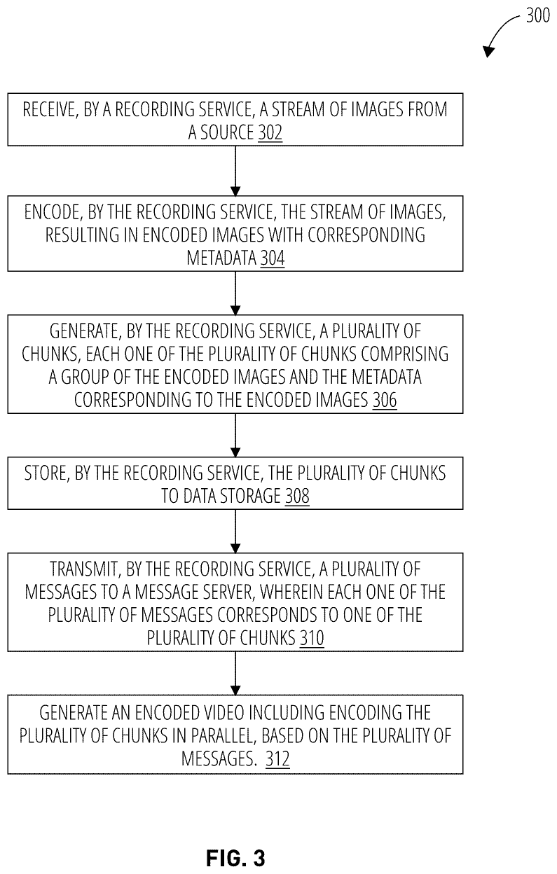

FIG. 3 illustrates an example method 300 for processing and encoding a video stream, in accordance with an embodiment. The method may be performed by a dynamic workflow engine that is carried out by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof.

Method 300 illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in method 300 may be performed in an order different than presented, and that not all of the blocks in the method may be performed.

Method 300 as well as other aspects of the present disclosure may be performed automatically (e.g., without human guidance or intervention), except for when human input is expressly indicated in the present disclosure.

In block 302, method 300 receives, by a recording service, a stream of images from a source. The source may be a video capture device, a gaming application, a server, a video conferencing server, a camera, or other computing device. The source may be communicated with over a computer network.

In block 304, method 300 encodes, by the recording service, the stream of images, resulting in encoded images with corresponding metadata. The stream of images may comprise raw frames with raw images that would otherwise be unwieldy to copy, store, or transmit, if not encoded. The encoded images may have a desired format (e.g., frame dimensions, image dimensions, image resolution, etc.) with reduced memory footprint relative to the raw images.

In block 306, method 300 generates, by the recording service, a plurality of chunks, each one of the plurality of chunks comprising a group of the encoded images and the metadata corresponding to the encoded images. In an example, the recording service may fit a predetermined number of frames into each chunk. The recording service may apply a compression and grouping algorithm to encapsulate those frames with the associated metadata. In an example, the recording service may generate each chunk as a . zip file.

In block 308, method 300 stores, by the recording service, the plurality of chunks to data storage. The data storage may be a remote data storage, or a cloud-based data storage. The data storage may be accessible over a computer network. Each chunk may be individually stored and accessed.

In block 310, method 300 transmits, by the recording service, a plurality of messages to a message server, wherein each one of the plurality of messages corresponds to one of the plurality of chunks. In an embodiment, the data storage may receive and transmit chunks according to a chunk ID. For example, a client (e.g., an encoding service) may retrieve a chunk from the data storage by providing a chunk ID to the data storage. The chunk ID may be read by the encoding service in the corresponding message. The data storage will transmit to the encoding service, the chunk that corresponds to that chunk ID.

In block 312, method 300 generates an encoded video by encoding the plurality of chunks in parallel, based on the plurality of messages. In an embodiment, generating the encoding video comprises receiving each of the plurality of messages by a plurality of encoding services. In an embodiment, a plurality of encoding services may download and encode the chunks, as they are notified by the message server that a chunk is available for processing. Each encoding service may apply a codec to the chunk, to transform the frames in that chunk to a desired format, with desired image dimensions, compression rate, image resolution, or other desired characteristics. Each encoding service may apply the same codec, so that the encoded chunks, when combined, have the same video format (e.g., MPEG-1. MPEG-2, MPEG-4, MOV, AVI, WMV, H.264, etc.).

At block 312, each encoding service may upload the encoded chunk to the data storage. A combiner service may download all the encoded chunks from the data storage. The combiner service may access the metadata for each encoded chunk, and determine the correct order of those encoded chunks based on the metadata. For example, the metadata may include the sequence number and/or time stamp of each frame in each chunk. The combiner service may put all the frames in the proper order, and encapsulate save these ordered frames as a single file, to generate the encoded video. The encoded video may be saved to data storage, where it may further be transmitted to a user as a download, or streamed as playback to a user over the computer network, or both.

FIG. 4 shows an example of a data processing system for parallel video processing, in accordance with an embodiment. Aspects described with respect to FIG. 4 may apply to other sections and/or other figures, and vice versa.

Generally, data processing system 400 may comprise a recording service 440 that receives and chunks the initial raw image stream 404, a plurality of encoding services 442 that each retrieve and encode the chunks, and a combiner service 444 that takes the encoded chunks and combines them, as described below.

Recording service 440 may receive a video stream 404 from a video streaming source 402. In an embodiment, the video streaming source 402 may be a real-time video streaming source. For example, the video stream 404 may comprise a stream of images (e.g., raw video) of a capture that is currently still being captured. The video stream 404 may be stored in local memory in a queue (e.g., in RAM memory) on a frame-by-frame basis. The raw video frames may be captured and stored in a queue 406. The recording service 440 may apply an image encoder 408 to each of the images of each frame, and store these encoded frames to local server memory 410. For example, the recording service 440 may consume the video frames from the queue 406, and apply a codec to each image to convert each image into a compressed image format, such as a JPG.

The recording server 440 may group these encoded frames 416 into respective chunks by compressing and/or encapsulating the group of frames at block 412. Further, the metadata describing timestamp and/or sequence numbering of the frames and images grouped in that chunk may be encapsulated within the chunk. The resulting chunks 446 may be stored to cloud storage 420. Further, for each chunk, the recording service 440 sends a corresponding message 460 to messaging service 408. This message 460 may be referred to as an invocation message which triggers downstream actions by the message server 418, such as to cause encoding services 442 to process the respective chunk uploaded to cloud storage 420.

Encoding service 442 receives a message 448 indicating that a chunk is ready to be processed. The message may comprise information (e.g., a chunk ID, an IP address, etc.) that the encoding service 442 may use to download the corresponding chunk 450 from data storage 420. The encoding service 442 may be subscribed to message server 418 to receive a notification each time a message is ready on the message server 418 to be consumed. At block 422, the encoding service communicates with cloud storage 420 (e.g., through one or more request/response messages) to receive the corresponding chunk 450 from the cloud storage 420 and store this to local memory 434. Once downloaded, the encoding service 442 may, at block 424, extract the video data and metadata file from the downloaded chunk (e.g., an unzipping operation). The resulting video frames and metadata 436 may be encoded at block 414 by applying a codec. The codec may correspond to a desired format such as, for example, MPEG-4, MOV, AVI, or other video formats such as those mentioned herein. The encoding service 442 uploads the resulting encoded chunk 452 to cloud storage 420. Although shown as one cloud storage 420, it should be understood that the same or different cloud storages may be used to store the chunks generated by the recording service 440, and those generated from encoding service 442. In an embodiment, the encoding service 442 may store the metadata 456 corresponding to that chunk 452 into a database 428.

In an embodiment, after processing the last chunk, an encoding service 442 that handles that last chunk may send an invocation to the combiner service 444. The encoding service 442 may determine that a chunk is the last chunk, based on an indication in the metadata of that chunk, or based on collectively tallying how many chunks have been encoded, and comparing that to a total number of chunks to be processed. For example, the recording service 440 may mark a chunk as being the last chunk when the recording service 440 that the incoming raw stream has ended. This may be based on the recording service 440 receiving a signal from the video source 402 which may be in the raw video stream or separate, or both. In another embodiment, the recording service 402 may count the total chunks made and uploaded to the data storage, and store this number in the data base 428 and/or in the metadata of the last chunk. When the encoding service 442 processes the last chunk with the indication that this is the last chunk, the encoding service 442 may store the total number of chunks into the data base 428, if not already stored there. Understanding that the order of encoding the chunks can be performed out of chunk order, the encoding service 442 may check if the current number of chunks encoded by the collective encoding services 442 is equal to the total number, and if not, the last chunk signal 454 is not sent to the combiner service 444. Subsequent encoding services 442 that encode chunks may further process chunks that are still in the cloud storage 420, and increment the tally (e.g., a counter) for chunks that have been encoded, until that number is the same as the total number of chunks in the database 428. When that occurs, the encoding service 442 may transmit the last chunk signal 454 to the combiner service 444 to go ahead and combine the encoded chunks in data storage 420. It should be understood that this and other algorithms, usage of counters, and/or metadata may be used to determine that the last chunk has been processed, without departing from the scope of the present disclosure, and are applicable to all embodiments in the present disclosure, such as, for example, as described in any of the other figures.

The combiner service 444 may, in response to receiving the invocation message, download all the processed video chunks from the cloud storage 420 at block 430. The downloaded encoded chunks 426 may be stored to local memory 462. The combiner service 444 may, at block 438, concatenate all the video chunks. The combiner service 444 may retrieve metadata 458 from the database 428, to determine chunk order. Additionally, or alternatively, the combiner service 444 may determine chunk order based on a chunk's file name (as generated by each encoding service 442). The combiner service 444 may upload the resulting concatenated and encoded video 432 to the cloud storage 432.

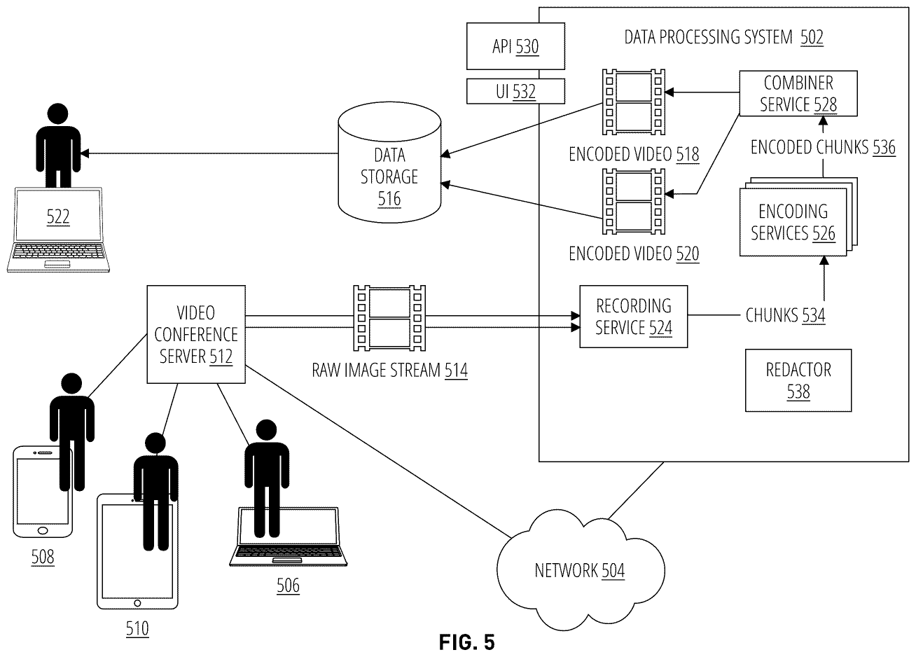

FIG. 5 shows an example embodiment of a distributed data processing system for processing a video, in accordance with an embodiment. Data processing system 502 may correspond to a data processing system or method, as described with respect to other figures, and vice versa.

Data processing system 502 may comprise a plurality of independent and asynchronously working services. Data processing system 502 may be coupled to other devices such as, for example, a video conference server 512, over a computer network 504.

As described in detail in other sections, the recording service 524 may receive raw image stream 514 from the video conference server 512, encode each image (e.g., to a jpeg), and chunk the images stream. The encoding services 526 may process these chunks in parallel to encode each chunk. The combiner service 528 may combine the encoded chunks to generate an encoded video 518, which may be an encoded version of raw image stream 514. The encoded video 518 may be stored to data storage 518. Because the chunks are encoded in parallel by encoding services 526, the overall time to encode the raw image stream 514 is greatly reduced, and in particular, is much less dependent on the duration of the raw image stream.

Through a user device 522, a user may download the encoded video 518 from data storage 516. For example, data processing system 502 may receive a request from user device 522 to download the encoded video 518. The data processing system 502 may transmit the encoded video 518, to the user device 522. In an example, the data processing system may comprise an application programming interface API 530 and/or a UI 532 that receives user input requesting to download an encoded video. Using the operations described, the data processing system may make this encoded video available within a short or predetermined duration of time after the video capture ends, and this duration may be independent of video duration.

In an embodiment, the raw image stream 514 may be received from a video conference server 512. The video conference server 512 may combine video that is captured from a plurality of user devices such as, for example, 506, 508, and 510. The video conference may transmit the resulting raw image stream 514 to the data processing system 502 and the recording service 524.

In an embodiment, the data processing system may include encoding services that are grouped to, in parallel, generate different versions (e.g., different encoding) of the same video capture. For example, each of the encoding services may generate N number of encoded chunks from a single chunk, each of those encoded chunks may be encoded with a different codec, and/or with different dimensions, image resolutions, frame resolutions, etc. As a result, when the last chunk is encoded, the resulting number of encoded chunks 536 may be N×the total number of chunks 534. Once given the signal that the last chunk is processed, the combiner service 528 may combine each of the encoded chunks 536 with the same encoding, to generate N number of encoded videos. For example, the combiner service 528 may combine a first plurality of encoded chunks 536 corresponding to a first encoding or codec, to generate a first encoded video 518, and combine a second plurality of encoded chunks 536 corresponding to a second encoding or codec, to generate a second encoded video 520. The different versions 518 and 520 may comprise different memory sizes, image resolution, frame resolution, size, aspect ratio, data format, etc. The user device 522 may choose which encoded video to download, based on preference, network conditions, user device capabilities, etc.

In an example, nearly all of the of the videos (e.g., 99% or greater) recorded by recording systems are made available to the end users by the data processing system 502, in a fixed amount of time after the video conference ends. In an example, the fixed time is less than 4 minutes. In an example, the fixed time is less than 3 minutes. In an example, the fixed time is less than 2.5 minutes, regardless of varying duration time of the raw image stream 514. Existing systems may process the same image stream in a more duration-dependent manner, for example, taking 0.6*video call duration, to provide an equivalent quality encoded video recording that is ready for download.

In an embodiment data processing system 502 may comprise additional processing components, such as a redactor 538. A redactor 538 may comprise an algorithm (e.g., a machine learning algorithm, a natural language processor, an object recognition algorithm, a text recognition algorithm, etc.) to detect sensitive information in the raw image stream and redact it (e.g., by blurring, blocking, or deleting an area of an image or images with the sensitive information. The redactor 538 may be integral to any of the services, or a standalone service that is in the pipeline after the raw image stream is first encoded by the recording service 524, and before the product is made ready to download as the encoded video.

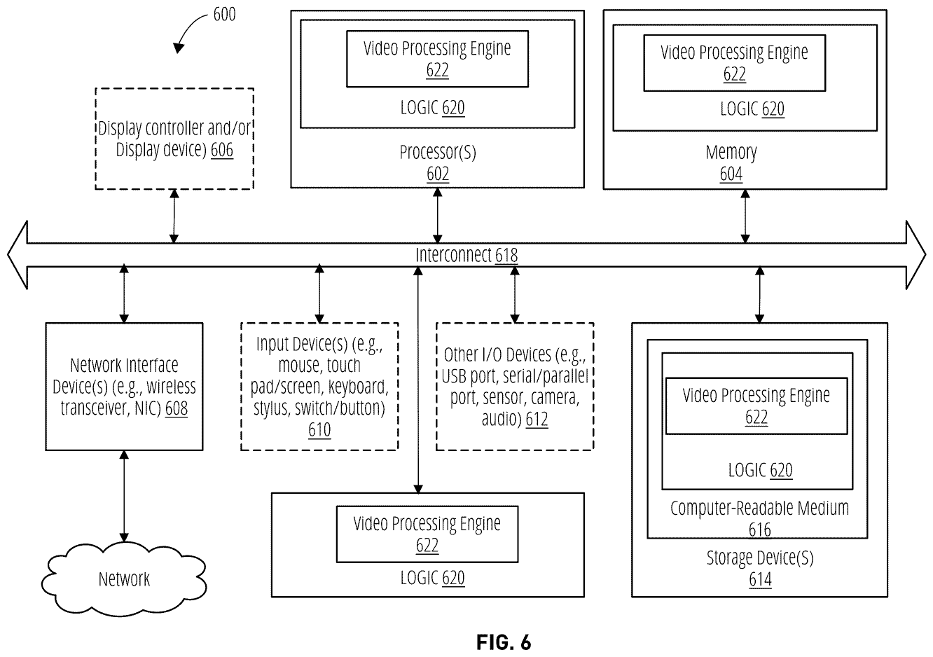

FIG. 6 is a block diagram illustrating an example of a data processing system which may be used with one embodiment. For example, system 600 may represent any of data processing systems described above performing any of the processes or methods described in the present disclosure.

System 600 can include various different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 600 is intended to show a high level view of many components of the computer system. However, it is to be understood that additional components may be present in certain implementations and furthermore, different arrangement of the components shown may occur in other implementations. System 600 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 600 includes processor 602, memory 604, and additional components 608, 610, 612, 614, and 620 which may be coupled over a bus or an interconnect 618. Processor 602 may represent a single processor or multiple processors with a single processor core or multiple processor cores included therein. Processor 602 may represent one or more general-purpose processors such as a microprocessor, a central processing unit (CPU), or the like. More particularly, processor 602 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 602 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 602, which may be a low power multi-core processor socket such as an ultra-low voltage processor, may act as a main processing unit and central hub for communication with the various components of the system. Such processor can be implemented as a system on chip (SoC). Processor 602 is configured to execute instructions for performing the operations and steps discussed herein. System 600 may further include a graphics interface that communicates with controller 606, which may include a display controller, a graphics processor, and/or a display device (e.g., an electronic display, a head up display, etc.).

Processor 602 may communicate with memory 604, which in one embodiment can be implemented via multiple memory devices to provide for a given amount of system memory. Memory 604 may include one or more volatile storage (or memory) devices such as random access memory (RAM), dynamic RAM (DRAM), synchronous DRAM (SDRAM), static RAM (SRAM), or other types of storage devices. Memory 606 may store information including sequences of instructions that are executed by processor 602, or any other device. For example, executable code and/or data of a variety of operating systems, device drivers, firmware (e.g., input output basic system or BIOS), and/or applications can be loaded in memory 606 and executed by processor 602. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 600 may further include IO devices such as, for example, network interface device(s) 608, optional input device(s) 610, and other optional IO device(s) 612. Network interface device 608 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 610 may include a mouse, a touch pad, a touch sensitive screen (which may be integrated with display device 606), a pointer device such as a stylus, and/or a keyboard (e.g., physical keyboard or a virtual keyboard displayed as part of a touch sensitive screen). For example, input device 612 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 610 may include an audio device. An audio device may include a speaker and/or a microphone to facilitate voice-enabled functions, such as voice recognition, voice replication, digital recording, and/or telephony functions. Other IO devices 612 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. Devices 612 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 618 via a sensor hub (not shown), while other devices such as a keyboard or thermal sensor may be controlled by an embedded controller (not shown), dependent upon the specific configuration or design of system 600.

To provide for persistent storage of information such as data, applications, one or more operating systems and so forth, a mass storage (not shown) may also couple to processor 602. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor(s) 602, e.g., via a serial peripheral interface (SPI). This flash device may provide for non-volatile storage of system software, including a basic input/output software (BIOS) as well as other firmware of the system.

Storage device 614 may include computer-accessible storage medium 616 (also known as a machine-readable storage medium or a computer-readable medium) on which is stored one or more sets of instructions or software (e.g., module, unit, and/or logic 620) embodying any one or more of the methodologies or functions described herein. Module/unit/logic 620 may also reside, completely or at least partially, within memory 604 and/or within processor 602 during execution thereof by data processing system 600, memory 604 and processor 602 also constituting machine-accessible storage media. Module/unit/logic 620 may further be transmitted or received over a network via network interface device 608.

Computer-readable storage medium 616 may also be used to store some software functionalities described above persistently. While computer-readable storage medium 616 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media, or any other non-transitory machine-readable medium.

Module/unit/logic 620, components and other features described herein can be implemented as discrete hardware components or integrated in the functionality of hardware components such as ASICS, FPGAs, DSPs or similar devices. In addition, module/unit/logic 620 can be implemented as firmware or functional circuitry within hardware devices. Further, module/unit/logic 620 can be implemented in any combination hardware devices and software components.

Logic 620 may include video processing engine 622. The video processing engine 622 may perform the operations described, such as those corresponding to a data processing system as described in other sections, and/or the method 300.

Note that while system 600 is illustrated with various components of a data processing system, it is not intended to represent any particular architecture or manner of interconnecting the components; as such details are not germane to embodiments of the present invention. It will also be appreciated that network computers, handheld computers, mobile phones, servers, and/or other data processing systems which have fewer components or perhaps more components may also be used with embodiments of the invention.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the invention also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

In some aspects, this disclosure may include the language, for example, “at least one of [element A] and [element B].” This language may refer to one or more of the elements. For example, “at least one of A and B” may refer to “A,” “B,” or “A and B.” Specifically, “at least one of A and B” may refer to “at least one of A and at least one of B,” or “at least of either A or B.” In some aspects, this disclosure may include the language, for example, “[element A], [element B], and/or [element C].” This language may refer to either of the elements or any combination thereof. For instance, “A, B, and/or C” may refer to “A,” “B,” “C,” “A and B,” “A and C,” “B and C,” or “A, B, and C.”

What is claimed is:

1. A method, performed by a data processing system comprising:
receiving, by a recording service, a stream of images from a video streaming source;
encoding, by the recording service, the stream of images, resulting in encoded images with corresponding metadata;
generating, by the recording service, a plurality of chunks, each one of the plurality of chunks comprising a group of the encoded images and the metadata corresponding to the encoded images;
storing, by the recording service, the plurality of chunks to data storage;
transmitting, by the recording service, a plurality of messages to a message server, wherein each one of the plurality of messages corresponds to one of the plurality of chunks; and
generating an encoded video including encoding the plurality of chunks in parallel, based on the plurality of messages.

2. The method of claim 1, wherein generating the encoded video comprises:
receiving, by a first encoding service, a first message of the plurality of messages from the message server, based on receiving a notification from the message server that one of the plurality of messages is received by the message server;
downloading, by the first encoding service, a first chunk of the plurality of chunks from the data storage, based on the first message;
encoding, by the first encoding service, the first chunk with a codec to generate a first encoded chunk;
storing, by the first encoding service, the first encoded chunk to the data storage;
receiving, by a second encoding service, a second message of the plurality of messages from the message server, based on receiving a second notification from the message server that one of the plurality of messages is received by the message server;
downloading, by the second encoding service, a second chunk of the plurality of chunks from the data storage, based on the second message;
encoding, by the second encoding service, the second chunk with the codec to generate a second encoded chunk; and
storing, by the second encoding service, the second encoded chunk to the data storage.

3. The method of claim 2, wherein the encoding the first chunk by the first encoding service and the encoding the second chunk by the second encoding service is performed in parallel.

4. The method of claim 2, wherein generating the encoded video comprises:
determining, by the second encoding service, based on the metadata corresponding to the second chunk, that the second chunk is a last chunk of the plurality of chunks; and
in response to determining that the second chunk is the last chunk, transmitting a message to a combiner service indicating that the last chunk is processed.

5. The method of claim 4, wherein generating the encoded video comprises:
receiving, by the combiner service, the message indicating that the last chunk of the plurality of chunks is processed;
in response to receiving the message, downloading, by the combiner service, the first encoded chunk and the second encoded chunk from the data storage; and
concatenating a plurality of encoded chunks including the first encoded chunk and the second encoded chunk, to generate the encoded video.

6. The method of claim 5, wherein concatenating the plurality of encoded chunks comprises determining a sequential order of the plurality of encoded chunks based on the metadata, and concatenating the plurality of encoded chunks in the sequential order.

7. The method of claim 1, further comprising transmitting the encoded video to a user device.

8. The method of claim 1, wherein generating the encoded video comprises:
combining a first plurality of encoded chunks to generate a first encoded video, and
combining a second plurality of encoded chunks to generate a second encoded video,
wherein the first plurality of encoded chunks are generated by a plurality of first encoding services using a first codec, and wherein the second plurality of encoded chunks are generated by a second plurality of encoding services using a second codec.

9. The method of claim 1, wherein the metadata comprises a timestamp or a sequence associated with the group of encoded images relative to the stream of images.

10. The method of claim 1, wherein generating, by the first service, the plurality of chunks, is performed while the stream of images are being captured or while the stream of images are being received.

11. A non-transitory computer readable storage medium including instructions that when executed by a processing device, causes the processing device to perform operations comprising:
receiving, by a recording service, a stream of images from a video streaming source;
encoding, by the recording service, the stream of images, resulting in encoded images with corresponding metadata;
generating, by the recording service, a plurality of chunks, each one of the plurality of chunks comprising a group of the encoded images and the metadata corresponding to the encoded images;
storing, by the recording service, the plurality of chunks to data storage;
transmitting, by the recording service, a plurality of messages to a message server, wherein each one of the plurality of messages corresponds to one of the plurality of chunks; and
generating an encoded video including encoding the plurality of chunks in parallel, based on the plurality of messages.

12. The non-transitory computer readable storage medium of claim 11, wherein generating the encoded video comprises:
receiving, by a first encoding service, a first message of the plurality of messages from the message server, based on receiving a notification from the message server that one of the plurality of messages is received by the message server;
downloading, by the first encoding service, a first chunk of the plurality of chunks from the data storage, based on the first message;
encoding, by the first encoding service, the first chunk with a codec to generate a first encoded chunk;
storing, by the first encoding service, the first encoded chunk to the data storage;
receiving, by a second encoding service, a second message of the plurality of messages from the message server, based on receiving a second notification from the message server that one of the plurality of messages is received by the message server;
downloading, by the second encoding service, a second chunk of the plurality of chunks from the data storage, based on the second message;
encoding, by the second encoding service, the second chunk with the codec to generate a second encoded chunk; and
storing, by the second encoding service, the second encoded chunk to the data storage.

13. The non-transitory computer readable storage medium of claim 12, wherein the encoding the first chunk by the first encoding service and the encoding the second chunk by the second encoding service is performed in parallel.

14. The non-transitory computer readable storage medium of claim 12, wherein generating the encoded video comprises:
determining, by the second encoding service, based on the metadata corresponding to the second chunk, that the second chunk is a last chunk of the plurality of chunks; and
in response to determining that the second chunk is the last chunk, transmitting a message to a combiner service indicating that the last chunk is processed.

15. The non-transitory computer readable storage medium of claim 14, wherein generating the encoded video comprises:
receiving, by the combiner service, the message indicating that the last chunk of the plurality of chunks is processed;
in response to receiving the message, downloading, by the combiner service, the first encoded chunk and the second encoded chunk from the data storage; and
concatenating a plurality of encoded chunks including the first encoded chunk and the second encoded chunk, to generate the encoded video.

16. A data processing system comprising:
a processor; and
a memory storing instructions that, when executed by the processor, configure the data processing system to perform operations comprising:
receiving, by a recording service, a stream of images from a video streaming source;
encoding, by the recording service, the stream of images, resulting in encoded images with corresponding metadata;
generating, by the recording service, a plurality of chunks, each one of the plurality of chunks comprising a group of the encoded images and the metadata corresponding to the encoded images;
storing, by the recording service, the plurality of chunks to data storage;
transmitting, by the recording service, a plurality of messages to a message server, wherein each one of the plurality of messages corresponds to one of the plurality of chunks; and
generating an encoded video, based on the plurality of messages and combining the plurality of chunks.

17. The data processing system of claim 16, wherein generating the encoded video:
receiving, by a first encoding service, a first message of the plurality of messages from the message server, based on receiving a notification from the message server that one of the plurality of messages is received by the message server;
downloading, by the first encoding service, a first chunk of the plurality of chunks from the data storage, based on the first message;
encoding, by the first encoding service, the first chunk with a codec to generate a first encoded chunk;
storing, by the first encoding service, the first encoded chunk to the data storage;
receiving, by a second encoding service, a second message of the plurality of messages from the message server, based on receiving a second notification from the message server that one of the plurality of messages is received by the message server;
downloading, by the second encoding service, a second chunk of the plurality of chunks from the data storage, based on the second message;
encoding, by the second encoding service, the second chunk with the codec to generate a second encoded chunk; and
storing, by the second encoding service, the second encoded chunk to the data storage.

18. The data processing system of claim 17, wherein the encoding the first chunk by the first encoding service and the encoding the second chunk by the second encoding service is performed in parallel.

19. The data processing system of claim 17, wherein generating the encoded video comprises:
determining, by the second encoding service, based on the metadata corresponding to the second chunk, that the second chunk is a last chunk of the plurality of chunks; and
in response to determining that the second chunk is the last chunk, transmitting a message to a combiner service indicating that the last chunk is processed.

20. The data processing system of claim 19, wherein generating the encoded video comprises:
receiving, by the combiner service, the message indicating that the last chunk of the plurality of chunks is processed;
in response to receiving the message, downloading, by the combiner service, the first encoded chunk and the second encoded chunk from the data storage; and
concatenating a plurality of encoded chunks including the first encoded chunk and the second encoded chunk, to generate the encoded video.
